(19) United States
(12) Patent Application Publication
(10) Pub. No.: US 2026/0368979 A1
(43) Pub. Date: Nov. 19, 2026

(54) Method for Evaluating Motion Videos Generated by Neural Network Models

(71) Applicant: Adobe Inc., San Jose, CA (US)

(72) Inventors: Kuldeep KULKARNI, Bagalkote (IN); Balaji Vasan SRINIVASAN, Bengaluru (IN); Aishwarya AGARWAL, Bengaluru (IN); Prateksha UDHAYANAN, Bengaluru (IN)

(73) Assignee: Adobe Inc., San Jose, CA (US)

(21) Appl. No.: 19/206,528

(22) Filed: May 13, 2025

(51) Int. Cl. G06T 13/00; G06T 7/00; G06T 7/11; G06T 7/215

(52) U.S. Cl. CPC G06T 13/00; G06T 7/0002; G06T 7/11; G06T 7/215; G06T 2207/10016

(57) ABSTRACT

Embodiments are disclosed for a video generation model evaluation system for evaluating the motion modeling capabilities of neural network models trained to generate video sequences. The method may include obtaining an input pair that includes a text prompt and an initial image frame from a ground truth video sequence. The disclosed systems and methods further comprise generating, by a video generation model, a video sequence depicting motion of at least one object based on the input pair. The disclosed systems and methods further comprise determining motion data representing the motion of the at least one object. The disclosed systems and methods further comprise scoring the video generation model in one or more motion categories based on the motion data. The disclosed systems and methods further comprise determining the scoring of the video generation model indicates high motion accuracy and providing the generated video sequence as an output video sequence.

### BACKGROUND

Video generation is the process of automating the creation of video content using video generation machine learning models. At the forefront of this rapidly-advancing field are image-to-video diffusion models that are capable of transforming an image into a video sequence based on a user prompt and/or narrative description. The ability to generate video sequences that accurately replicates the real-world can be an important factor in judging the quality of video generation models.

### SUMMARY

Introduced here are techniques/technologies that allow a video generation model evaluation system to evaluate the motion modeling capabilities of video generation models by identifying video generation models that output video sequences that model object movements accurately. This ensures that requested video sequences are of high quality and allows for feedback to be provided to enhance the training of video generation models.

More specifically, in one or more embodiments, a video generation model evaluation system evaluates and scores video sequences generated by video generation models, such as image-to-video diffusion models. To evaluate a video generation model, a text prompt and initial image frame are provided as input to the video generation model evaluation system. The text prompt can be a description that defines a visual narrative provided to at least one video generation models to generate a video sequence. The generated video sequence that is output by the video generation model is then scored in different aspects of motion: motion smoothness, motion direction, and motion speed. Based on the scores, the video generation model evaluation system can determine how accurately the video generation model captures the different aspects of motion. The scores can also be used to compare different video generations models to identify the generated video sequences with the highest motion accuracy. The score can also be provided as feedback used to improve the video generation model that generated the generated video sequence

In one or more embodiments, the text prompt and initial image frame are obtained from a curated motion dataset that includes ground truth video sequences for different types of motion: linear motion (e.g., where the direction of motion is in a single direction), rotational motion (e.g., where the motion path is circular around a fixed axis), and oscillatory motion (e.g., where the nature of motion is to-and-fro). To curate the motion dataset, ground truth video sequences are obtained that include one of the above-mentioned types of motion. Each initial image frame is a video frame extracted from one of the ground truth video sequences. Each text prompt is generated using a text prompt template to include a description of an object in one of the ground truth video sequences, a type of motion, and a speed of motion of the object, among other details. Once curated, the motion dataset can include multiple text prompt and initial image frame pairs that can be applied to video generation models to evaluate their motion modeling capabilities.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of evaluating motion videos generated by video generation models in accordance with one or more embodiments;

FIG. 2 illustrates a diagram of a process of generating motion modeling scores for motion videos generated by video generation models in accordance with one or more embodiments;

FIG. 3 illustrates example visualizations of distance matrices for video sequences with oscillatory motion in accordance with one or more embodiments;

FIG. 4 illustrates a schematic diagram of a video generation model evaluation system in accordance with one or more embodiments;

FIG. 5 illustrates a flowchart of a series of acts in a method of evaluating motion videos generated by video generation models in accordance with one or more embodiments;

FIG. 6 illustrates a flowchart of a series of acts in a method of generating a motion dataset for evaluating motion videos generated by video generation models in accordance with one or more embodiments;

FIG. 7 shows an example of a guided diffusion model according to aspects of the present disclosure.

FIG. 8 shows an example of a U-Net according to aspects of the present disclosure.

FIG. 9 shows an example of a method for conditional media generation according to aspects of the present disclosure.

FIG. 10 shows a diffusion process according to aspects of the present disclosure.

FIG. 11 shows a flow diagram depicting an algorithm as a step-by-step procedure for training a machine-learning model according to aspects of the present disclosure.

FIG. 12 shows an example of a method for training a diffusion model according to aspects of the present disclosure.

FIG. 13 shows an example of a computing device according to aspects of the present disclosure.

FIG. 14 shows an example of an exemplary computing device according to aspects of the present disclosure.

### DETAILED DESCRIPTION

One or more embodiments of the present disclosure include a video generation model evaluation system trained to evaluate the motion modeling capabilities of video generation models. Motion in a recorded video sequence is the result of the movement of one or more of the following: objects, characters, and the camera. To accurately replicate real-world scenarios, these motions must adhere to the principles of physics, such as the law of inertia and the law of momentum, among several others. Fine-grained motion details including subtle shifts, accelerations, and decelerations contribute significantly to the perception of realism. This makes motion-related details a critical focus in the evaluation of videos generated by image-to-video diffusion models. However, some video generation models do not fully understand the inherent motion characteristics of various objects, and even in cases where a video generation model has some understanding of motion, they can sometimes fail to generate a coherent-looking video. For example, the shape and structure of an object may be deformed, objects that should move together may be generated with different and/or changing velocities, etc.

Existing methods of evaluating generated video sequences have focused on scoring and enhancing video generation along the dimensions of generic video quality aspects, such as temporal coherence, semantic consistency and aesthetic quality. While some existing methods introduces action recognition and average flow scores to assess the motion quality, they do not account for motion-specific fine-grained details. These evaluation methods are thus incapable of determining whether the video sequences are accurately modeling motion.

To address these and other deficiencies in conventional systems, the video generation model evaluation system of the present disclosure evaluates the motion of objects in generated video sequence to determine whether the video generation model adheres to laws of motion when generating video. By scoring the motion smoothness, motion speed, and motion direction of the generated video sequence, the video generation model evaluation system can filter out higher quality video sequences that model motion accurately, in addition to provide feedback to improve existing video generation models.

The video generation model evaluation system of the present disclosure presents improved evaluations of video generation models that addresses the limitations of the existing solutions. One advantage of the video generation model evaluation system of the present disclosure is the ability to identify video generation models with superior motion modeling capabilities by comparing the motion scores generated for each generated video sequence. Another advantage is that the method can provide feedback for incorporating nuanced motion details during additional training or refinement processes for video generation models. This can enhance both evaluation and development phases, facilitating the creation of more realistic and engaging user content.

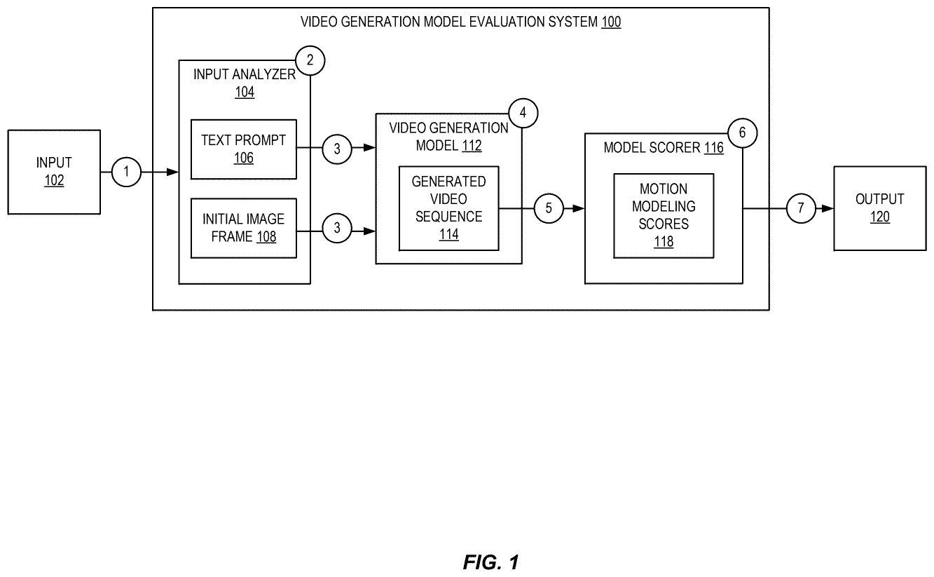

FIG. 1 illustrates a diagram of a process of evaluating motion videos generated by video generation models in accordance with one or more embodiments. As shown in FIG. 1, a video generation model evaluation system 100 receives an input 102, as shown at numeral 1. For example, the video generation model evaluation system 100 receives the input 102 from a user via a computing device or from a memory or storage location. In one or more embodiments, the input 102 includes a text prompt 106 and an initial image frame 108. In one or more embodiments, the initial image frame 108 is a video frame from a ground truth video sequence from a curated motion dataset. In one or more embodiments, the input 102 includes a selection or identification of one or more video generation model for evaluation by the video generation model evaluation system 100. In one or more embodiments, the input 102 can be provided through the use of a graphical user interface (GUI). In one or more embodiments, the input 102 can be uploaded directly or the user can provide a URL to a location storing the input 102.

In one or more embodiments, the input 102 is part of a dataset that includes multiple text prompts 106 and initial image frames 108 corresponding to multiple ground truth video sequences. Although FIG. 1 is described with respect to a single text prompt 106 and initial image frame 108, the input 102 can include multiple text prompts 106 and initial image frames 108 corresponding to multiple ground truth video sequences that can be processed serially or in parallel. In one or more embodiments, the dataset is a well-curated and diverse set that includes examples for different motion types. Motion refers to the change in position of an object with respect to time. Motions in the physical world can be complex, and each motion type has a distinct set of properties associated with it. In one or more embodiments, the video generation model evaluation system 100 evaluates video generation models in the following motion types: linear motion (e.g., where the direction of motion is in a single direction), rotational motion (e.g., where the motion path is circular around a fixed axis), and oscillatory motion (e.g., where the nature of motion is to-and-fro). Linear motion can be further subdivided into two types: fluid elements and non-fluid elements. In one or more embodiments, the object types selected for fluid elements are rivers, waterfalls, clouds, fire, and smoke, and object types for non-fluid elements are the following rigid bodies: cable cars, conveyor belts, vehicles, and escalators. In one or more embodiments, the object types selected for rotational motion are ceiling fans, Ferris wheels, and vehicle wheels. In one or more embodiments, the dataset only includes initial image frames and videos that provide a complete view of the rotation, while also ensuring that the change in pixel positions exhibits circular motion. Oscillatory motion can be further subdivided into two types: motions with small displacements and motions with large displacements. In one or more embodiments, the object types selected for motions with small displacements are leave swaying, flowers swaying, and candles flickering, and the object types selected for motions with large displacements are pendulum, metronome, rocking chair, toy horse, and swing. This results in twenty object types for the dataset: nine object types for linear motion, three object types for rotational motion, and eight object types for oscillatory motion. In one or more embodiments, to create a diverse dataset, the video generation model evaluation system 100 obtains ground truth video sequences for each of the plurality of object types described above.

In one or more embodiments, to generate the dataset, videos for each object type are obtained (e.g., from video libraries or public platforms). Videos obtained can vary widely, including videos that include only object motion, some that include only camera motion, and others that include both camera and object motion. They also can feature different types of interactions, such as object-object interactions, human-object interactions, and several others. In one or more embodiments, to facilitate accurate assessment of the motion quality produced by video generation models, the following constraints are applied to the data collection process: (1) Static Camera-videos in the dataset have minimal to zero camera motion, allowing the focus to be on object movement and study the motion properties in detail, which is challenging to isolate when multiple components are in motion; (2) Single Object of Focus—videos in the dataset include a single object of focus, typically centered in the frame, which can aid in understanding object-specific motion properties and ensures compatibility with models that perform various cropping and resizing operations; (3) Object-Driven Motion—the motion in the ground truth videos primarily results from the object of focus, making the dataset a reliable option to study the motion properties of specific objects without distracting background movements; and (4) Diversity in Data—the collected videos ensure diversity in several aspects, including FPS (frames per second), recording angle (e.g., capturing object movement from different angles), foreground and background characteristics (e.g., object color, object shape, background color, etc.).

In one or more embodiments, a pre-processing stage is performed on the videos collected for the dataset. In some embodiments, as the videos collected for the dataset can be of differing durations, the pre-processing stage can include temporally segmenting the videos to obtain multiple smaller video segments having matching durations (e.g., approximately 2 seconds in duration). In such embodiments, the duration of the smaller video segments can be a user-defined value. In one or more embodiments, after the pre-processing stage, the dataset includes 1000 videos (e.g., 50 videos for each of the twenty object-types noted above). In one or more embodiments, the FPS of videos in the dataset can vary.

In one or more embodiments, after curating the videos for the dataset, the text prompts (e.g., text prompt 106) are generated to capture different motion properties, such as smoothness, speed, and direction. The text prompts will be provided to a video generation model with an image frame (e.g., initial image frame 108) from a corresponding from the dataset. In some embodiments, the text prompts are generated using a text prompt template. An example text prompt template can be as follows: “a cinemagraph of <object> moving in <direction>, at a <speed>, captured with a stationary camera.” In this example, the text prompt template includes the phrase, “captured with a stationary camera,” as an indicator to the video generation models to adhere to constraints 1 and 3 above. The direction prompt can vary for the different motion types. For linear motion, there can be two direction prompts per image frame, such as <downwards, upwards> and <left-to-right, right-to-left>. For circular motion, direction prompts per image frame can be <clockwise, counter-clockwise>. For oscillatory motion, the direction prompt is omitted, as the motion is a to-and-fro motion. For all motion types, the speed prompt can be one of three options: <slow, moderate, fast>. In one or more embodiments, using the preceding text prompt template results in six text prompts per video for linear and circular motion video, and four text prompts per video for oscillatory motion video. This leads to a dataset of size 5,200 given the twelve object types for linear and rotational motion and the eight object types for oscillatory motion:

(6 text prompts×12 object types+4 text prompts×8 object types)×50 videos per object type=5,200

The resulting dataset thus includes 5,200 unique pairs of <initial image frame, text prompt> pairs that can be provided as input to video generation models being evaluated by the video generation model evaluation system 100.

The video generation model evaluation system 100 includes an input analyzer 104 that receives the input 102. In some embodiments, the input analyzer 104 is configured to extract the text prompt 106 and the initial image frame 108 from the input 102, at numeral 2. After processing the input 102, the input analyzer 104 sends the text prompt 106 and the initial image frame 108 to a video generation model 112, as shown at numeral 3. In one or more embodiments, the video generation model 112 can be one of a plurality of video generation models 112 being evaluated by the video generation model evaluation system 100 using the same text prompt 106 and initial image frame 108. In such embodiments, the video generation model evaluation system 100 can evaluate the plurality of video generation models 112 serially or in parallel.

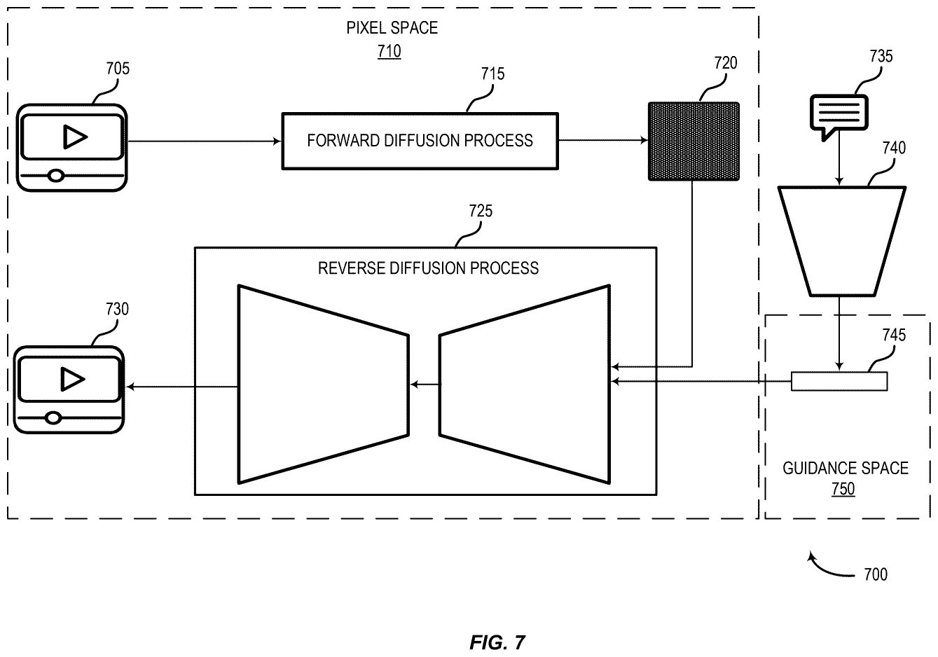

In one or more embodiments, the video generation model 112 generates a generated video sequence 114 using the text prompt 106 and the initial image frame 108, at numeral 4. In some embodiments, the video generation model 112 is a diffusion model. Examples of diffusion models, their architecture, and their training are described below, at least with respect to FIGS. 7-14. In one or more embodiments, the video generation model 112 is an image-to-video diffusion model, a type of neural network configured to generate a video sequence when given an initial image frame 108 and a text prompt 106 describing a desired video sequence using the initial image frame 108. By providing context to the video generation model 112, the video generation model 112 may generate a comprehensive video sequence that is closely associated/related with the video invoked by the visual text of the text prompt 106. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. Additional details regarding diffusion models are described with respect to FIGS. 7-14.

In one or more embodiments, the video generation model 112 can be one of a plurality of video generation models being evaluated by the video generation model evaluation system 100 for their ability to accurately generate motion. After generating the generated video sequence 114, the generated video sequence 114 is sent to a model scorer 116, as shown at numeral 5.

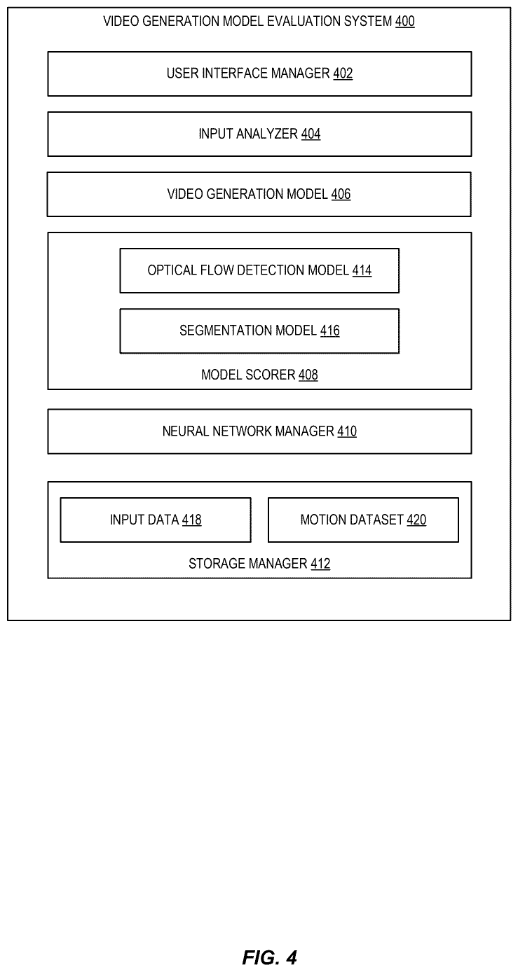

In one or more embodiments, the model scorer 116 generates motion modeling scores 118 for the video generation model 112, at numeral 6. In one or more embodiments, the model scorer 116 generates one or more of the following motion modeling scores 118: a motion smoothness score, a motion direction score, and a motion speed score. Additional details of the model scorer 116 are described with respect to FIG. 4.

After the video generation model evaluation system 100 generates the motion modeling scores 118 for the video generation model 112, video generation model evaluation system 100 can provide an output 120, as shown at numeral 7. In one or more embodiments, after the process described above in numerals 1-6, the output 120 is sent through a communications channel to the user device or computing device that provided the input requesting the evaluation of the video generation model 112, to another computing device associated with the user or another user, or to another system or application.

In one or more embodiments, the output 120 is the generated video sequence 114 when the motion modeling scores 118 for the generated video sequence 114 indicate that the video generation model 112 being evaluated models motion accurately, or more accurately than other generated video sequences generated by other video generation models using the same text prompt 106 and initial image frame 108. For example, the motion modeling scores 118 can be stored and/or associated with the generated video sequence 114 and/or with information indicating the video generation model 112. Concurrently or subsequently, the text prompt 106 and the initial image frame 108 can be provided to a plurality of different video generation models 112 to generate a plurality of generated video sequences 114. Using the motion modeling scores 118 for the generated video sequences 114 generated by each of the plurality of different video generation models 112, the video generation model evaluation system 100 can select the generated video sequence 114 with the highest motion modeling scores 118 (e.g., indicating greater motion accuracy in comparison to the scores for the other generated video sequences in the plurality of generated video sequences 114) as the output 120. In one or more embodiments, the video generation model evaluation system 100 generates a ranking of the plurality of different video generation models 112 based on the motion modeling scores 118. In such embodiments, the output 120 can be the generated ranking.

In some embodiment, additionally or alternatively, the motion modeling scores 118 can be provided as the output 120. In such embodiments, the motion modeling scores 118 can be used as feedback to enhance or improve the corresponding video generation model 112.

As discussed above, embodiments can be used to evaluate the motion modeling capabilities of video generation models. These video generation models may include diffusion models which receive a text input and generate an image, video, audio, or other output.

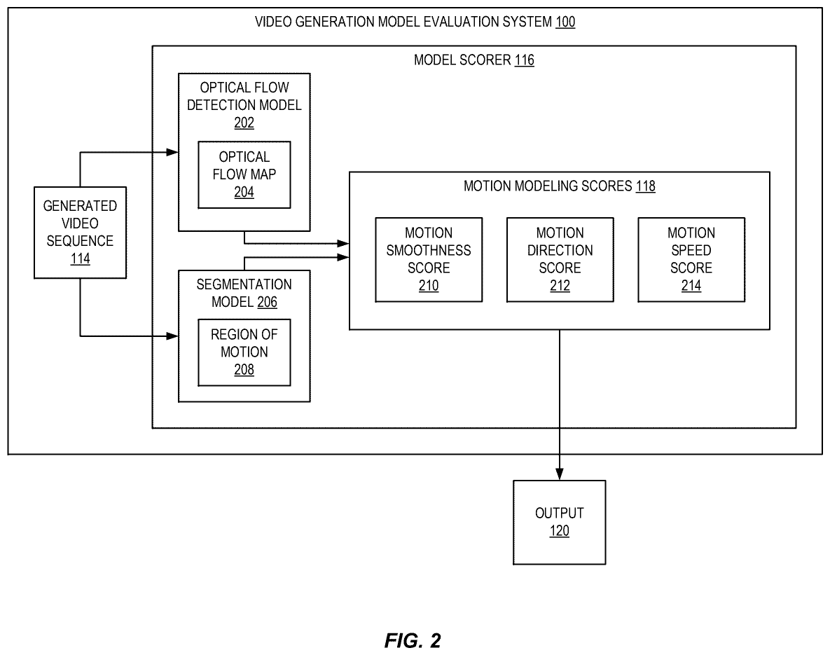

FIG. 2 illustrates a diagram of a process of generating motion modeling scores for motion videos generated by video generation models in accordance with one or more embodiments. In FIG. 2, a generated video sequence 114 generated by a video generation model 112 is provided to a model scorer 116. In one or more embodiments, the model scorer 116 includes an optical flow detection model 202 and a segmentation model 206.

In one or more embodiments, the optical flow detection model 202 generates an optical flow map 204 for frames of the generated video sequence 114. In embodiments, the optical flow map 204 indicates the velocity of each pixel between a first frame and a second frame, where the first frame and second frame are sequential frames of the generated video sequence 114. In one or more embodiments, given the generated video sequence 114, v_{gen}, the frames of the generated video sequence 114 can be defined as (i_{gen}_{₀}, i_{gen}_{₁}, . . . , i_{gen}_{ₜ₋₁}), where t is the number of frames in the generated video sequence 114. In one or more embodiments, the optical flow detection model 202 is the Recurrent All-Pairs Field Transforms (RAFT) model, a deep network architecture for optical flow. The optical flow detection model 202 computes the optical flow of the generated video sequence 114, F, as follows:

F=(f₀,f₁, . . . ,fₜ₋₁)=OpticalFlow(v_{gen})

where fₖ refers to the flow computed between i_{gen}_{ₖ} and i_{gen}_{ₖ₊₁}.

In one or more embodiments, the segmentation model 206 identifies a region of motion 208 for a frame i_{gen}_{ₖ} of the generated video sequence 114, where the region of motion 208 indicates the location of the object in motion. In one or more embodiments, the segmentation model 206 uses GroundingDINO, an object detector, and the Segment Anything Model (SAM), to identify and mask the region of motion 208. In such embodiments, GroundingDINO identifies the bounding box coordinates for the object in a given frame of the generated video sequence 114 as follows:

x₁_{ₖ},x₂_{ₖ},y₁_{ₖ},y₂_{ₖ}=GroundingDINO (i_{gen}_{ₖ},object)

and SAM identifies the finer masked region of the object within the bounding box coordinates as follows:

maskₖ=SAM(x₁_{ₖ},x₂_{ₖ},y₁_{ₖ},y₂_{ₖ})

where mask indicates the pixels where the object is located in the given frame of the generated video sequence 114.

For any given flow, fₖ, flow in the region of the bounding box is denoted as f_{bb}_{ₖ} (for flow between i_{gen}_{ₖ} and i_{gen}_{ₖ₊₁}). In cases where the bounding box region remains constant across frames, the flow for the entire generated video sequence 114 can be computed using x₁_{₀}, x₂_{₀}, y₁_{₀}, y₂_{₀} and can be denoted as F_{bb}, as follows:

f_{bb}_{ₖ}=fₖ[:,x₁_{ₖ}:x₂_{ₖ},y₁_{ₖ},:k]

F_{bb}=F[:,:,x₁_{₀}:x₂_{₀},y₁_{₀};y₂_{₀}]

For any given flow, fₖ, flow in the segmented region is denoted as fₘₐₛₖ_{ₖ}, and in cases where the segmented region remains constant across frames, the flow for the entire video is computed using fₘₐₛₖ_{₀}, and is denoted as Fₘₐₛₖ, as follows:

fₘₐₛₖ_{ₖ}=fₖ*maskₖ

Fₘₐₛₖ=F*mask₀

In one or more embodiments, the optical flow map 204 and the region of motion 208 are then used by the model scorer 116 to generate one or more motion modeling scores 118. In some embodiments, the model scorer 116 computes one or more of a motion smoothness score 210, a motion direction score 212, and a motion speed score 214.

### Motion Smoothness Score

In one or more embodiments, determining the motion smoothness score 210 for the generated video sequence 114 depends on the type of motion exhibited in the generated video sequence 114. As described previously, types of motion can include linear motion (fluid elements or rigid bodies), rotational motion, and oscillatory motion (small displacement or large displacement).

For the motion smoothness score 210 of linear motion of fluid elements, as continuous fluid motions, such as flowing water or billowing smoke, can be represented as a temporally constant 2D optical flow maps, a metric Flow-Constancy score (FC_Score), or motion smoothness score 210 is used to capture the constancy of optical flow values over time. In one or more embodiments, the model scorer 116 computes the optical flow map 204, F, and the region of motion 208, mask₀ for i_{gen}_{₀}, as described above. In embodiments, as the region of motion 208 for fluids is consistent across frames, mask, can be used as the values for all frames. In one or more embodiments, the masked flow, Fₘₐₛₖ, can be denoted as (f₀*mask₀, f₁*mask₀, . . . , fₜ₋₁*mask₀).

Given the masked flow, a Fast-Fourier Transform of Fₓ (flow in the x-direction) and F_{y} (flow in the y-direction) at each pixel can be computed to obtain Tₓ and T_{y}, as follows:

Tₓ,T_{y}=FFT(Fₓ,F_{y})

where Fₓ, F_{y}=Fₘₐₛₖ[:,0,:,:], Fₘₐₛₖ[:,1,:,:], which represents the x and y direction flows restricted only to the masked region.

In one or more embodiments, to formulate the constant flow property of fluids, the energy percentage of the zeroth frequency component is computed across all the pixels, as follows:

$${E}_{x} = {\sum }_{w , h} {\vert {T}_{x} \vert}^{2} , {E}_{y} = {\sum }_{w , h} {\vert {T}_{y} \vert}^{2}$$

$${E}_{x\_ 0 \_freq} = \frac{{E}_{x} [ 0 ]}{{\sum }_{f} {E}_{x}} , {E}_{y\_ 0 \_freq} = \frac{{E}_{y} [ 0 ]}{{\sum }_{f} {E}_{y}}$$

$$FC\_Score = ( \frac{{E}_{x\_ 0 \_freq} + {E}_{y\_ 0 \_freq}}{2} ) * 100$$

For a time-domain signal that has a constant value, the frequency-domain signal has the highest energy in the zeroth frequency and zero energy at all other frequencies. For fluid motions, the frequency signal obtained from a Fast-Fourier Transform indicates a smooth flow of motion if the energy of the zeroth frequency component is high.

For the motion smoothness score 210 of linear motion of rigid bodies, in order for the motion to appear smooth, all points on the object should move with a constant speed. If different points on the object move at different speeds, it can lead to deformations in the object across frames. This is different from the motion properties of fluid elements because for fluid elements, the speed at every pixel in the region of motion 208 remains constant over time. In contrast, for rigid bodies, the speed of all pixels in the region of motion 208 should be constant at any given instant of time. This ensures that the entire object moves uniformly without deformation, maintaining its shape and structure.

In one or more embodiments, a Constant-Speed Score (CS_Score) is determined to capture this property in rigid bodies. For every pair of consecutive frames (i_{gen}_{ₖ}, i_{gen}_{ₖ₊₁}), using fₘₐₛₖ_{ₖ}, the speed of motion at each pixel location in maskₖ is computed to obtain, Sₖ·(fₓ_{ₖ}, f_{y}_{ₖ}=fₘₐₛₖ_{ₖ}[0,:,:], fₘₐₛₖ_{ₖ} [1,:,:]).

In one or more embodiments, as the region of motion 208 is constantly changing, maskₖ is computed for every frame. This is different from the case of fluid elements where the region of motion 208 is constant and it suffices to compute it just once.

$${S}_{k} = \sqrt{{f}_{{x}_{k}}^{2} + {f}_{{y}_{k}}^{2}}$$

At each timestamp, k, the standard deviation of the speed is computed as follows:

$${s}_{k}^{std\_dev} = \sqrt{\frac{{\sum }^{p {c}^{k}} {( {S}_{k} - {\breve{S}}_{k} )}^{2}}{p {c}^{k} - 1}}$$

where pc^{k} is the number of pixels in the masked region maskₖ. An average of standard deviations computed at each timestamp is determined to produce the final metric CS_Score, or motion smoothness score 210, as follows:

$$CS\_Score = \frac{{\sum }_{k = 0}^{t - 1} {S}_{k}^{std\_dev}}{t - 1}$$

In one or more embodiments, the ideal standard deviation value should be 0 at each timestamp, thus producing CS_Score=0, indicating a constant speed of motion for all the pixels in the object region.

For rotational motion, every point on the rotating body should move with the same angular velocity. In one or more embodiments, since computing angular velocity from a 2D frame would require precise identification and estimation of the axis of rotation and radius, which is challenging, rotational motion is approximated using 2D-pixel values. In one or more embodiments, determining the motion smoothness score 210, or q_Score, for rotational motion of the generated video sequence 114 first includes computing the optical flow map 204, F. Next, for every pair of consecutive frames (i_{gen}_{ₖ}, i_{gen}_{ₖ₊₁}), the direction of motion is computed at each pixel location at time stamp k in the segmented region mask for frame (i_{gen}_{ₖ}). The direction of motion at timestamp k is as follows: (fₓ_{ₖ}, f_{y}_{ₖ}=fₘₐₛₖ_{ₖ}[0,:,:], fₘₐₛₖ_{ₖ}[1,:,:]).

$${θ}_{k} = flattened ( {tan}^{- 1} ( \frac{{f}_{{y}_{k}}}{{f}_{{x}_{k}}} ) )$$

A histogram of these angles is then computed, as follows: with a bin-width of 30 where values range, as follows:

h_{freq}_{ₖ}=Histogram(θₖ,bins)

where the bin-width is 30 degrees, and where bin values range from −180 degrees to 180 degrees (e.g., bins=−180°,−150°, . . . , 0°, . . . , 30°, . . . , 150°, 180°).

The difference between the frequency values of complementary bins is then determined. For example, for the bin in the range of (−150°, −180°), the complementary bin is (0°, 30°). The difference between the frequency values of complementary bins, D, can be determined as follows:

$$D ( {h}_{{freq}_{k}} ) = \frac{\vert {h}_{{freq}_{k} [ : 6 ]} - h\_ ( freq\_k ) [ 6 : ] \vert}{p {c}^{k}}$$

The final metric q_Score, or motion smoothness score 210, can be computed by taking an average of D(h_{freq}_{ₖ}) across all the frames to determine the average angle of motion of rotational body pixels, as follows:

$$q\_Score = \frac{{\sum }_{k = 0}^{t - 1} D ( {h}_{{freq}_{k}} )}{t - 1}$$

In an ideal case, for each pixel moving by θ∈[0,180) in the body performing rotational motion, there should be a complementary pixel moving in the opposite direction −180°+θ. This would lead to D(h_{freq}_{ₖ})=0, and thus leading to a q_Score of 0.

For oscillatory motion with small displacements, the motion is primarily of low-frequency components (e.g., trees, flowers, or candle flames flickering/moving in the breeze). These types of natural motions are quasi-periodic and the motion can be described as a superposition of a small number of harmonic oscillators represented with different frequencies, amplitudes, and phases. In one or more embodiments, the motion smoothness score 210 is a Low-Frequency Score (LF_Score) for capturing the presence of low-frequency components.

For a generated video sequence 114 with flowers and leaves, there is no need to segment out the region as: 1) the region of motion 208 is spread across the frame and localizing specific parts of the frame would lead to loss of information, and 2) the background is typically fairly consistent across frames, thus contributing to the 0-frequency component, which will be included in the low-frequency component. For a generated video sequence 114 with candles, the bounding box region determined as the region of motion 208 as computed on i_{gen}_{₀} is determined and kept fixed for all the frames of the generated video sequence 114.

The optical flow map 204, F, for flowers and leaves, and F_{bb} for candles, is generated as described previously. From optical flow map 204, F, or optical flow map 204, F_{bb}, the flow is obtained in the x and y directions, e.g., Fₓ and F_{y}. Next, the Fast-Fourier transform of Fₓ and F_{y} is computed to obtain Tₓ and T_{y}, followed by computing the energy of the signal at different frequencies, as described previously. This information is then used to compute the percentage of energy present in 25% of the lower-frequency components, as follows:

$${E}_{x\_ 25 \% \_freq} = \frac{{\sum }_{j}^{lf} {E}_{x} [ j ]}{{\sum }_{f} {E}_{x\_fft}} , {E}_{y\_ 25 \% \_freq} = \frac{{\sum }_{j}^{lf} {E}_{y} [ j ]}{{\sum }_{f} {E}_{y\_fft}}$$

where lf=25% of t−1. The LF_Score, or motion smoothness score 210 for oscillatory motion with small displacements, can then be computed as follows:

$$LF\_Score = ( \frac{{E}_{x\_ 25 \% \_freq} + {E}_{y\_ 25 \% \_freq}}{2} ) * 100$$

to indicate the percentage of energy in 25% of the low-frequency components. In one or more embodiments, the higher the percentage of energy in the low-frequency components, the smoother the video quality of the generated video sequence 114.

For oscillatory motion with large displacements, the motion is typically periodic (e.g., pendulum, metronome, swing). In such embodiments, the to-and-fro motion is repetitive (e.g., the pendulum will swing back to a same position multiple times), which leads to a same frame occurring multiple times, resulting in a repeating pattern. In one or more embodiments, when generated videos align with this repetitive nature, the observed motion is smooth. In one or more embodiments, the motion smoothness score 210 is a Periodicity Score (P_Score).

In one or more embodiments, to determine the P_Score, a distance-matrix (Z_{gen} of dimensions T×T) for the sequence of frames v_{gen}=(i_{gen}_{₀}, i_{gen}_{₁}, . . . , i_{gen}_{ₜ₋₁}) is constructed by computing pair-wise Euclidean distances, as follows:

Z_{gen}(i,j)=∥V(i)−V(j)∥²

where V is the flattened tensor of all frames (i_{gen}_{₀}, i_{gen}_{₁}, . . . , i_{gen}_{ₜ₋₁}).

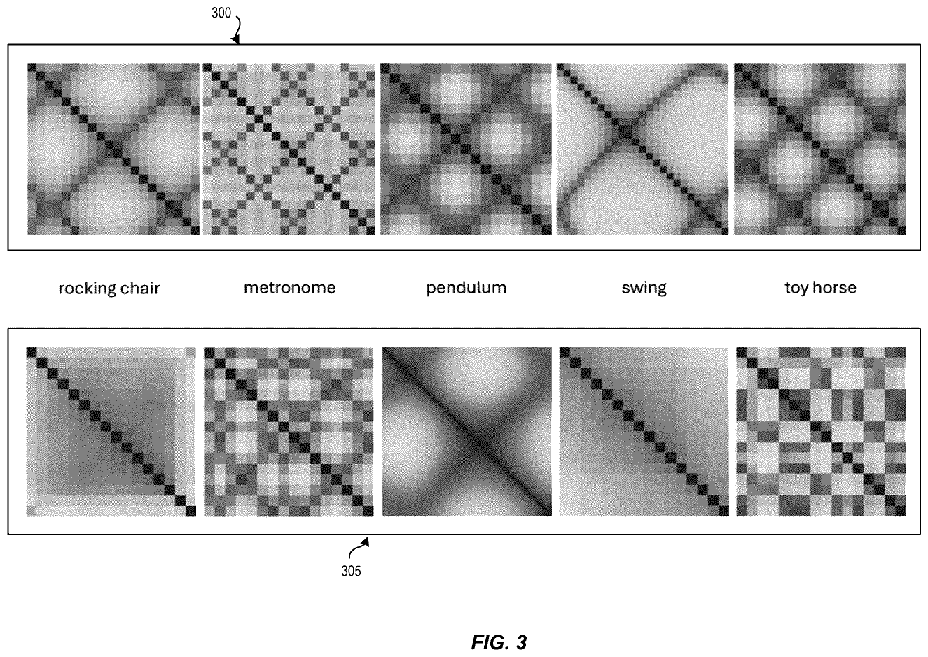

In one or more embodiments, distance matrices can be visualized and evaluated to determine whether the generated video sequence 114 exhibits periodic motion. In one or more embodiments, for a video having T frames, the distance for every pair of frames is computed, resulting in T×T scalar values, constituting a distance matrix. The matrices are treated as images and visualized. When the motion is oscillatory, the distance matrix, D, is a symmetric matrix with clearly visible repetitive patterns in its visualization. In contrast, when the motion is non-oscillatory, repetitive patterns do not appear in corresponding visualizations. FIG. 3 illustrates example visualizations of distance matrices for video sequences with oscillatory motion in accordance with one or more embodiments. FIG. 3 includes visualizations for motion of a rocking chair, metronome, pendulum, swing, and toy horse. As illustrated in FIG. 3, row 300 illustrates visualizations of a distance matrix for an object in a ground truth video sequence that is moving in an oscillatory motion with large displacements (e.g., a to-and-fro motion). Where motion is oscillatory with large displacements, repetitive patterns are expressed by the visualizations. Row 305 illustrates visualizations of a distance matrix for the same objects in a video sequence generated by video generation models. In this example, the generated video sequences for the metronome and pendulum exhibit some repetitive patterns, while the generated video sequences for the rocking chair, swing, and toy horse do not exhibit repetitive patterns.

In one or more embodiments, to capture the patterns in the distance matrices as numerical features, a Local Binary Pattern (LBP) image descriptor is computed. These features are used to train a linear support vector machine (SVM) to classify the visualizations between being periodic and non-periodic patterns (e.g., videos exhibiting repetitive motions vs. videos not exhibiting repetitive motions).

In one or more embodiments, training data for the SVM utilizes the distance matrices computed for ground truth videos provided in the benchmark. In such embodiments, the distance matrices computed for oscillatory motions with large displacements are labeled as oscillatory and the other distance matrices are labelled as non-oscillatory. The metric P-Score (Periodicity-Score) is the inference stage of the model, as produces an output of “0” or “1,” based on the following:

P_{score}=1, if SVM(Z_{gen})==oscillatory,else0

### Motion Direction Score

In one or more embodiments, determining the motion direction score 212 for the generated video sequence 114 depends on the type of motion exhibited in the generated video sequence 114. In one or more embodiments, as oscillatory motion does not have a motion direction (e.g., as the movement occurs in a to-and-fro manner), the motion direction score 212 is not computed for generated video sequences with oscillatory motion.

In one or more embodiments, the motion direction score 212 evaluates the ability of a video generation model (e.g., video generation model 112) to generate videos with diverse directions of motion and also assess the video generation model's ability to adhere to a specific direction mentioned in a text prompt (e.g., text prompt 106). Note that the direction of motion in the physical world does not directly translate to the pixel world. For example, the change in pixel positions does not always represent the directional change. This discrepancy can arise from the projection of the 3D world onto a 2D space. In one or more embodiments, the dataset, from which the text prompt 106 and initial image frame 108 are obtained, can be curated to include images with clear orientations and straightforward views of the object in motion.

In one or more embodiments, the dataset includes images that enable categorization of pixel movement direction into one of the following: left to right, right to left, downward, and upward, while avoiding more ambiguous and complex directional terms like “towards the camera.”

For the motion direction score 212 of linear motion of fluid elements, the region of motion 208, mask₀, is obtained once, for the first frame i_{gen}_{₀}. In one or more embodiments, the region of motion 208, mask₀, is obtained using GroundingDINO and SAM, as described previously. Then, for each frame i_{gen}_{ᵢ}, fₘₐₛₖ_{ᵢ} is determined as follows:

fₘₐₛₖ_{ᵢ}=fᵢ*mask₀

For the motion direction score 212 of linear motion of rigid bodies, the region of motion 208 is computed for each frame of the generated video sequence 114, to obtain: mask₀, mask₁, . . . , maskₜ₋₁. For each frame i_{gen}_{ᵢ}, fₘₐₛₖ_{ᵢ} is determined as follows:

fₘₐₛₖ_{ᵢ}=fᵢ*maskᵢ

In one or more embodiments, to accurately capture the direction of motion in pixel space, the x and y components of the optical flow fₘₐₛₖ_{ᵢ} are analyzed independently for each frame. In one or more embodiments, the number of positive and negative flow values in both the x-direction (x_{flow}) and y-direction (y_{flow}) are counted and then evaluated against the following conditions, depending on the pixel movement direction (e.g., left to right, right to left, downward, and upward), as follows:
1) Left-to-Right Motion: Majority of x_{flow} values are positive

Dir(fₘₐₛₖ_{ᵢ})=True if Σ_{i,j∈P}I(x_{flow(i,j)}>0)>Σ_{i,j∈P}I(x_{flow(i,j)}≤0),else False
2) Right-to-Left Motion: Majority of x_{flow} values are negative.

Dir(fₘₐₛₖ_{ᵢ})=True if Σ_{t,j∈P}I(x_{flow(i,j)}<0)<Σ_{i,j∈P}I(x_{flow(i,j)}≥0),else False
3) Downward Motion: Majority of y_flow values are positive.

Dir(fₘₐₛₖ_{ᵢ})=True if Σ_{i,j∈P}I(y_{flow(i,j)}>0)>Σ_{i,j∈P}I(y_{flow(i,j)}≤0),else False
4) Upward Motion: Majority of y_flow values are negative.

Dir(fₘₐₛₖ_{ᵢ})=True if Σ_{i,j∈P}I(y_{flow(i,j)}<0)>Σ_{i,j∈P}I(y_{flow(i,j)}≥0),else False

where I(⋅) is the indicator function that returns 1 if the condition is true and 0 otherwise. This ensures that the predominant direction of motion is accurately captured. This value is aggregated across all frames to obtain the motion direction score 212 for linear motion, Dir_Score. as follows:

$$Dir\_Score = \frac{{\sum }_{t - 1} Dir ( {f}_{m a s {k}_{i}} )}{t - 1}$$

### Motion Speed Score

In one or more embodiments, determining the motion speed score 214 evaluates the ability of a video generation model (e.g., video generation model 112) to understand the notion of speed. In one or more embodiments, three speed-related variations in the text prompt 106 can be evaluated: “moving at a slow pace,” “moving at a moderate pace,” and “moving at a fast pace,” where the videos generated for these three prompt variation are: v_{gen}_{ₛ₁}, v_{gen}_{ₛ₂}, v_{gen}_{ₛ₃}, respectively. For each of these videos, the motion magnitude is computed based on the following:

$$Motion Magnitude = \frac{{\sum }_{k = 0}^{t - 1} {\sum }_{i = 0}^{p {c}^{k}} \sqrt{{f}_{{x}_{{k}_{i}}}^{2} + {f}_{{y}_{{k}_{i}}}^{2}}}{( t - 1 ) * ( p {c}^{k} )}$$

where pc^{k} refers to the number of pixels in the segmented region. We obtain 3 values as mmₛ₁, mmₛ₂, mmₛ₃. The motion speed score 214, Speed_Score, can then be defined as follows:

$$Speed\_Score = \{ \begin{matrix}1 , if {mm}_{s 1} < m {m}_{s 2} and {mm}_{s 2} < m {m}_{s 3} \\ 0 , else\end{matrix}$$

After the video generation model evaluation system 100 generates the motion modeling scores 118 based on the generated video sequence 114, the motion modeling scores 118 can be sent as an output 120 to provide feedback to enhance the corresponding video generation model used to generate the generated video sequence 114. In other embodiments, the motion modeling scores 118 can be used in comparison with other generated video sequences generated by other video generation models using the same inputs. In such embodiments, the scores can be compared to select a best generated video sequence.

FIG. 4 illustrates a schematic diagram of a video generation model evaluation system (e.g., “video generation model evaluation system” described above) in accordance with one or more embodiments. As shown, the video generation model evaluation system 400 may include, but is not limited to, a user interface manager 402, an input analyzer 404, a video generation model 406, a model scorer 408, a neural network manager 410, and a storage manager 412. The model scorer 408 includes an optical flow detection model 414 and a segmentation model 416. The storage manager 412 includes input data 418 and a motion dataset 420.

As illustrated in FIG. 4, the video generation model evaluation system 400 includes a user interface manager 402. For example, the user interface manager 402 allows users to provide input data to the video generation model evaluation system 400. In some embodiments, the user interface manager 402 provides a user interface through which the user can upload one or more of text prompts and initial image frames, as discussed above. Alternatively, or additionally, the user interface may enable the user to download one or more of text prompts and initial image frames from a local or remote storage location (e.g., by providing an address (e.g., a URL or other endpoint) associated with a data source). Alternatively, or additionally, the user interface may enable the user to select one or more text prompts and initial image frames from a curated motion dataset (e.g., motion dataset 420 used to evaluate video generation models).

As further illustrated in FIG. 4, the video generation model evaluation system 400 also includes an input analyzer 404. The input analyzer 404 analyzes an input received by the video generation model evaluation system 400 to identify text prompts and initial image frames extracted from ground truth video sequences.

As further illustrated in FIG. 4, the video generation model evaluation system 400 also includes video generation model 406. In one or more embodiments, the video generation model 406 is an image-to-video diffusion model that generates video given a text prompt describing requested content of the video and an initial image frame. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As further illustrated in FIG. 4, the video generation model evaluation system 400 also includes model scorer 408. In one or more embodiments, the model scorer 408 evaluates the motion modeling capabilities of the video generation model 406 by analyzing generated video sequences produced by the video generation model 406. In one or more embodiments, the model scorer 408 generates scores in a plurality of motion categories, including motion smoothness, motion direction, and motion speed. In one or more embodiments, in order to evaluate the video generation model 406, the model scorer 408 includes an optical flow detection model 414 and a segmentation model 416. In some embodiments, the optical flow detection model 414 is the Recurrent All-Pairs Field Transforms (RAFT) model, a deep network architecture that generates an optical flow map that indicates the velocity of each pixel between consecutive frames of a generated video sequence. In some embodiments, the segmentation model 416 identifies a region of motion for a frame of the generated video sequence, where the region of motion indicates the location of the object in motion. In one or more embodiments, the segmentation model 416 uses GroundingDINO, an object detector that identifies the coordinates for a bounding box that includes the object in a given frame of the generated video sequence. The segmentation model 416 the uses the Segment Anything Model (SAM), to identify and mask the region of motion within the bounding box. In such embodiments, GroundingDINO identifies the bounding box coordinates for the object in a given frame of the generated video sequence 114 as follows:

As illustrated in FIG. 4, the video generation model evaluation system 400 also includes a neural network manager 410. Neural network manager 410 may host a plurality of neural networks or other machine learning models, such as video generation model 406, optical flow detection model 414, and segmentation model 416. The neural network manager 410 may include an execution environment, libraries, and/or any other data needed to execute the machine learning models. In some embodiments, the neural network manager 410 may be associated with dedicated software and/or hardware resources to execute the machine learning models. Although depicted in FIG. 4 as being hosted by a single neural network manager 410, in various embodiments the neural networks may be hosted in multiple neural network managers and/or as part of different components.

As illustrated in FIG. 4, the video generation model evaluation system 400 also includes the storage manager 412. The storage manager 412 maintains data for the video generation model evaluation system 400. The storage manager 412 can maintain data of any type, size, or kind as necessary to perform the functions of the video generation model evaluation system 400. The storage manager 412, as shown in FIG. 4, includes input data 418 and motion dataset 420. In particular, the input data 418 may include text prompts and initial image frames to be provided to one or more video generations models (e.g., video generation model 406) to generate video sequences. The motion dataset 420 can include curated ground truth video sequences selected based on the type of motion exhibited (e.g., linear, rotational, oscillatory, etc.) and a plurality of text prompts generated using a text prompt template and selected initial image frames selected from the ground truth video sequences, as discussed in additional detail above. In particular, in one or more embodiments, the input data 418 can be selected from the motion dataset 420 for evaluation of one or more video generation models.

Each of the components 402-412 of the video generation model evaluation system 400 and their corresponding elements (as shown in FIG. 4) may be in communication with one another using any suitable communication technologies. It will be recognized that although components 402-412 and their corresponding elements are shown to be separate in FIG. 4, any of components 402-412 and their corresponding elements may be combined into fewer components, such as into a single facility or module, divided into more components, or configured into different components as may serve a particular embodiment.

The components 402-412 and their corresponding elements can comprise software, hardware, or both. For example, the components 402-412 and their corresponding elements can comprise one or more instructions stored on a computer-readable storage medium and executable by processors of one or more computing devices. When executed by the one or more processors, the computer-executable instructions of the video generation model evaluation system 400 can cause a client device and/or a server device to perform the methods described herein. Alternatively, the components 402-412 and their corresponding elements can comprise hardware, such as a special purpose processing device to perform a certain function or group of functions. Additionally, the components 402-412 and their corresponding elements can comprise a combination of computer-executable instructions and hardware.

Furthermore, the components 402-412 of the video generation model evaluation system 400 may, for example, be implemented as one or more stand-alone applications, as one or more modules of an application, as one or more plug-ins, as one or more library functions or functions that may be called by other applications, and/or as a cloud-computing model. Thus, the components 402-412 of the video generation model evaluation system 400 may be implemented as a stand-alone application, such as a desktop or mobile application. Furthermore, the components 402-412 of the video generation model evaluation system 400 may be implemented as one or more web-based applications hosted on a remote server. Alternatively, or additionally, the components of the video generation model evaluation system 400 may be implemented in a suite of mobile device applications or “apps.”

As shown, the video generation model evaluation system 400 can be implemented as a single system. In other embodiments, the video generation model evaluation system 400 can be implemented in whole, or in part, across multiple systems. For example, one or more functions of the video generation model evaluation system 400 can be performed by one or more servers, and one or more functions of the video generation model evaluation system 400 can be performed by one or more client devices. The one or more servers and/or one or more client devices may generate, store, receive, and transmit any type of data used by the video generation model evaluation system 400, as described herein.

In one implementation, the one or more client devices can include or implement at least a portion of the video generation model evaluation system 400. In other implementations, the one or more servers can include or implement at least a portion of the video generation model evaluation system 400. For instance, the video generation model evaluation system 400 can include an application running on the one or more servers or a portion of the video generation model evaluation system 400 can be downloaded from the one or more servers. Additionally or alternatively, the video generation model evaluation system 400 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including a motion dataset stored at the one or more servers. Moreover, the client device can receive a request (i.e., via user input) to evaluate a video generation model for its motion modeling capabilities based on an input text prompt and initial image frame. Upon receiving the request, the one or more servers can automatically perform the methods and processes described above.

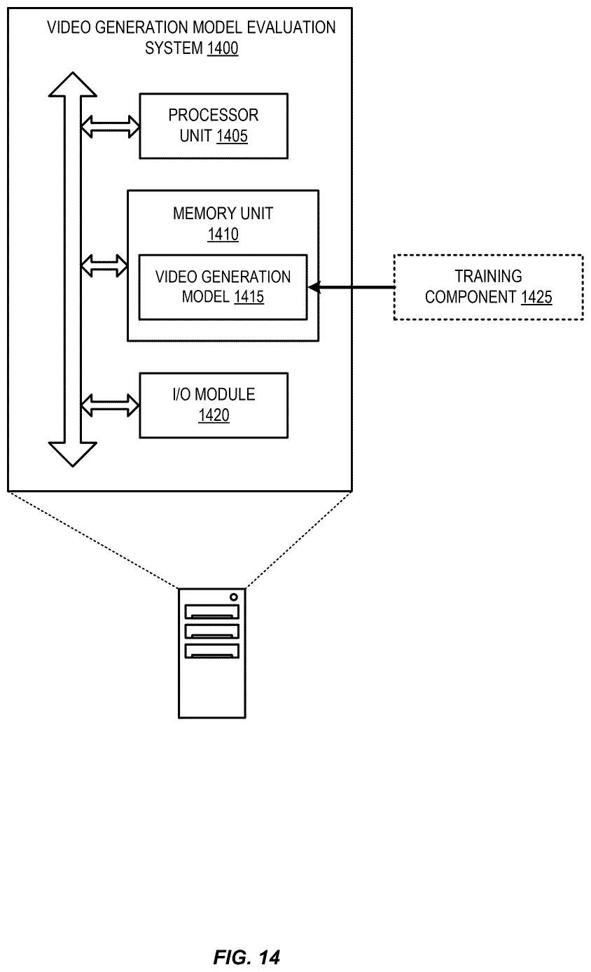

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 14. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 14.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 14.

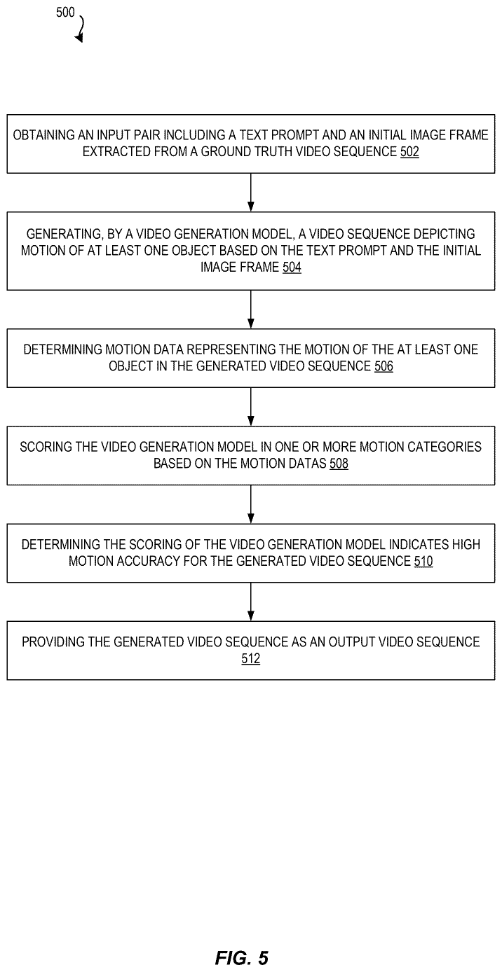

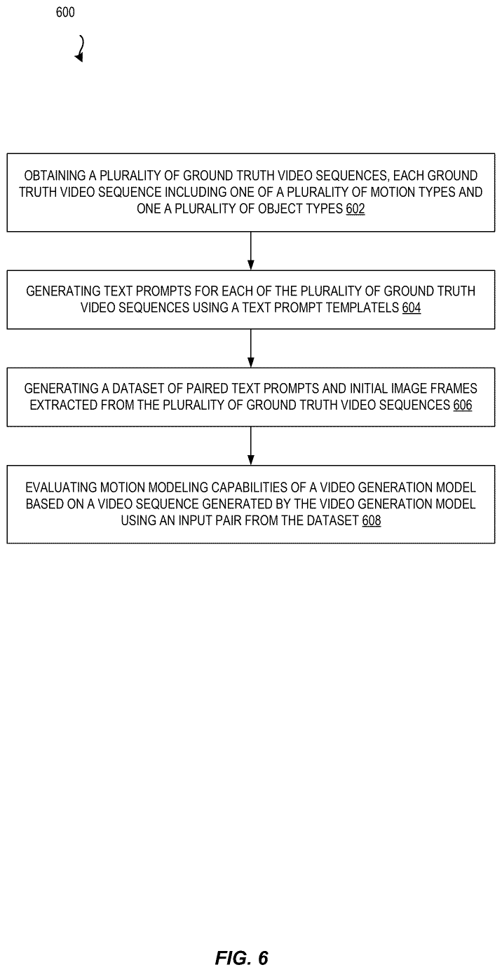

FIGS. 1-4, the corresponding text, and the examples, provide a number of different systems and devices that evaluate the motion modeling capabilities of video generation models. In addition to the foregoing, embodiments can also be described in terms of flowcharts comprising acts and steps in a method for accomplishing a particular result. For example, FIGS. 5 and 6 illustrate flowcharts of exemplary methods in accordance with one or more embodiments. The methods described in relation to FIGS. 5 and 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of a series of acts in a method of evaluating motion videos generated by video generation models in accordance with one or more embodiments. In one or more embodiments, the method 500 is performed in a digital medium environment that includes the video generation model evaluation system 400. The method 500 is intended to be illustrative of one or more methods in accordance with the present disclosure and is not intended to limit potential embodiments. Alternative embodiments can include additional, fewer, or different steps than those articulated in FIG. 5.

As illustrated in FIG. 5, the method 500 includes an act 502 of obtaining an input pair including a text prompt and an initial image frame extracted from a ground truth video sequence. In one or more embodiments, a video generation model evaluation system receives a text prompt and an initial image frame as an input. In one or more embodiments, the video generation model evaluation system receives the input from a user (e.g., via a computing device). In one or more embodiments, the user may select or provide the input in an application, or the user may submit the input to a web service or an application configured to receive inputs. In other embodiments, the text prompt and the initial image frame can be retrieved from a motion dataset by the video generation model evaluation system. For example, the video generation model evaluation system can automatically retrieve one or more text prompt and initial image frame pairs from the motion dataset to evaluate a video generation model. In one or more embodiments, the ground truth video sequence includes a single object of focus, typically centered in the frame.

As illustrated in FIG. 5, the method 500 includes an act 504 of generating, by a video generation model, a video sequence depicting motion of at least one object based on the text prompt and the initial image frame. In one or more embodiments, the text prompt and the initial image frame are then provided to a video generation model, such as an image-to-video diffusion model, trained to generate video sequences based on a narrative described in the text prompt. The generated videos sequence can utilize the initial image frame as a starting point for the generation video. In one or more embodiments, the video generation model can be one of a plurality of video generation models being evaluated by the video generation model evaluation system (e.g., using the same text prompt and initial image frame pair or a different text prompt and initial image frame pair). In such embodiments, video generation model evaluation system can evaluate the plurality of video generation models serially or in parallel. In one or more embodiments, the generated video sequence includes motion of the single object of focus in the ground truth video sequence.

As illustrated in FIG. 5, the method 500 includes an act 506 of determining motion data representing the motion of the at least one object in the generated video sequence. In one or more embodiments, the video generation model evaluation system includes an optical flow detection model that generates an optical flow map for frames of the generated video sequence.

The optical flow map indicates the velocity of each pixel between sequential frames of the generated video sequence. In one or more embodiments, the optical flow detection model is the Recurrent All-Pairs Field Transforms (RAFT) model, a deep network architecture for optical flow. In one or more embodiments, the video generation model evaluation system also includes a segmentation model identifies a region of motion of the generated video sequence, which masks the pixel locations of the object in motion. In one or more embodiments, the segmentation model uses GroundingDINO, an object detector, and the Segment Anything Model (SAM), to identify and mask the region of motion. In such embodiments, GroundingDINO identifies the bounding box coordinates for the object in a given frame of the generated video sequence and SAM identifies the finer masked region of the object within the bounding box coordinates.

As illustrated in FIG. 5, the method 500 includes an act 508 of scoring the video generation model in one or more motion categories based on the motion data. The video generation model evaluation system can use the optical flow map and the region of motion information to generate motion smoothness, motion direction, and motion speed scores, as described previously.

As illustrated in FIG. 5, the method 500 includes an act 510 of determining the scoring of the video generation model indicates high motion accuracy for the generated video sequence. In one or more embodiments, based on the scores, the video generation model evaluation system can determine how accurately the video generation model captures the different aspects of motion. In some embodiments, the video generation model evaluation system can evaluate multiple video generation system using the same input pair. In such embodiments, the scores can be used to compare the video sequences generated by the multiple video generations models to identify the generated video sequences with the highest motion accuracy.

As illustrated in FIG. 5, the method 500 includes an act 512 of providing the generated video sequence as an output video sequence. In one or more embodiments, the generated video sequence is provided as the output video sequence when the motion modeling scores indicate that the video generation model models motion accurately, or more accurately than other generated video sequences generated by other video generation models using the same text prompt and initial image. For example, the motion modeling scores can be stored and/or associated with the generated video sequence and/or with information indicating the video generation model. In one or more embodiments, the generated video sequence is sent as the output video sequence through a communications channel to the user device or computing device that provided the input pair requesting the evaluation of the video generation model, to another computing device associated with the user or another user, or to another system or application.

FIG. 6 illustrates a flowchart of a series of acts in a method of generating a motion dataset for evaluating motion videos generated by video generation models in accordance with one or more embodiments. In one or more embodiments, the method 600 is performed in a digital medium environment that includes the video generation model evaluation system 400. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of obtaining a plurality of ground truth video sequences, each ground truth video sequence including one of a plurality of motion types and one a plurality of object types. In one or more embodiments, the video generation model evaluation system obtains ground truth video sequences for each of the following motion types: linear motion (e.g., where the direction of motion is in a single direction), rotational motion (e.g., where the motion path is circular around a fixed axis), and oscillatory motion (e.g., where the nature of motion is to-and-fro). Linear motion can be further subdivided into two types: fluid elements and non-fluid elements. In one or more embodiments, the object types selected for ground truth video sequences for linear motion include fluid elements are rivers, waterfalls, clouds, fire, and smoke, and object types for non-fluid elements are the following rigid bodies: cable cars, conveyor belts, vehicles, and escalators. In one or more embodiments, the object types selected for ground truth video sequences for rotational motion are ceiling fans, Ferris wheels, and vehicle wheels. In one or more embodiments, the dataset only includes initial image frames and videos that provide a complete view of the rotation, while also ensuring that the change in pixel positions exhibits circular motion. Oscillatory motion can be further subdivided into two types: motions with small displacements and motions with large displacements. In one or more embodiments, the object types selected for ground truth video sequences for motions with small displacements are leave swaying, flowers swaying, and candles flickering, and the object types selected for ground truth video sequences for motions with large displacements are pendulum, metronome, rocking chair, toy horse, and swing. This results in twenty object types for the dataset: nine object types for linear motion, three object types for rotational motion, and eight object types for oscillatory motion. In one or more embodiments, as the ground truth video sequences can vary in duration, these ground truth video sequences can be pre-processed into smaller video segments or video clips of a same or matching duration.

As illustrated in FIG. 6, the method 600 includes an act 604 of generating text prompts for each of the plurality of ground truth video sequences using a text prompt template. In one or more embodiments, text prompts are generated to capture different motion properties, such as smoothness, speed, and direction. The text prompts are generated with respect to an initial image frame from one of the ground truth video sequences. An example text prompt template can be as follows: “a cinemagraph of <object> moving in <direction>, at a <speed>, captured with a stationary camera.” In this example, the text prompt template includes the phrase, “captured with a stationary camera,” as an indicator to the video generation models to ensure that the generated video sequence has zero or minimal camera motion to allowing the focus to be on object movement and that the motion primarily results from the object of focus. The direction prompt can vary for the different motion types. For linear motion, there can be two direction prompts per image frame, such as <downwards, upwards> and <left-to-right, right-to-left>. For circular motion, direction prompts per image frame can be <clockwise, counter-clockwise>. For oscillatory motion, the direction prompt is omitted, as the motion is a to-and-fro motion. For all motion types, the speed prompt can be one of three options: <slow, moderate, fast>.

As illustrated in FIG. 6, the method 600 includes an act 606 of generating a dataset of paired text prompts and initial image frames extracted from the plurality of ground truth video sequences. In one or more embodiments, using the preceding text prompt template results in six text prompts per video for linear and circular motion video, and four text prompts per video for oscillatory motion video. This leads to a dataset of size 5,200 given the twelve object types for linear and rotational motion and the eight object types for oscillatory motion:

(6 text prompts×12 object types+4 text prompts×8 object types)×50 videos per object type=5,200

The resulting dataset thus includes 5,200 unique pairs of <initial image frame, text prompt> pairs that can be provided as input to video generation models being evaluated by the video generation model evaluation system 100.

As illustrated in FIG. 6, the method 600 includes an act 608 of evaluating motion modeling capabilities of a video generation model based on a video sequence generated by the video generation model using an input pair from the dataset. In one or more embodiments, an input pair is selected based on an input selection or randomly by the video generation model evaluation system. For example, an input pair can be selected from the dataset based on a selection of a motion type and object type. The video generation model evaluation system can then evaluate the motion modeling capabilities of the video generation model generating scores for the video generation model in one or more motion categories based on the video sequence generated by the video generation model, as described previously.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

### Architecture: Pixel Diffusion

FIG. 7 shows an example of a guided diffusion model 700 according to aspects of the present disclosure. In some examples, guided diffusion model 700 describes the operation and architecture of the video generation model 1415 described with reference to FIG. 14. The guided latent diffusion model 700 depicted in FIG. 7 is an example of, or includes aspects of, a video generation model (e.g., video generation model 112) as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 740 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

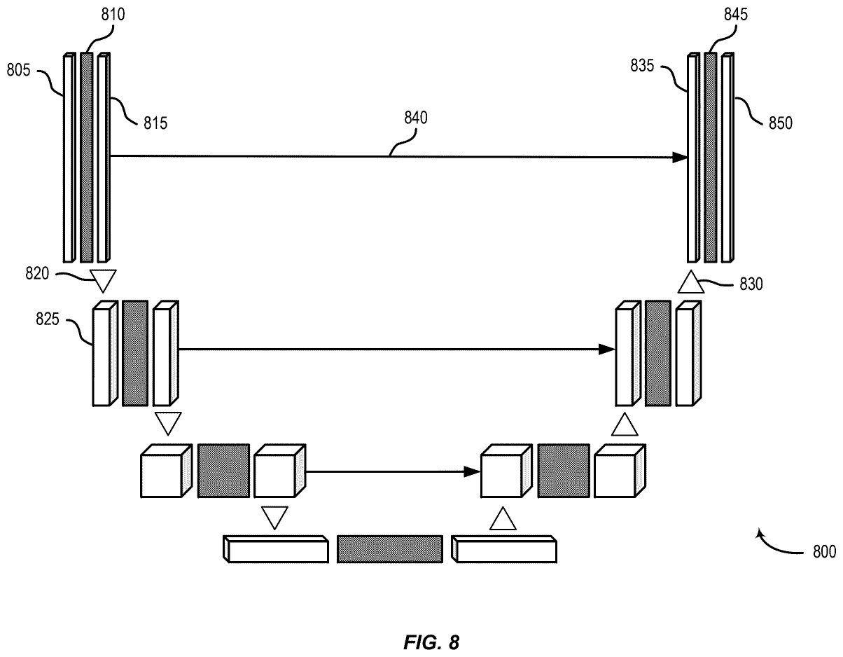

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of the video generation model 1415 described with reference to FIG. 14. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

### Inference: Conditional Generation

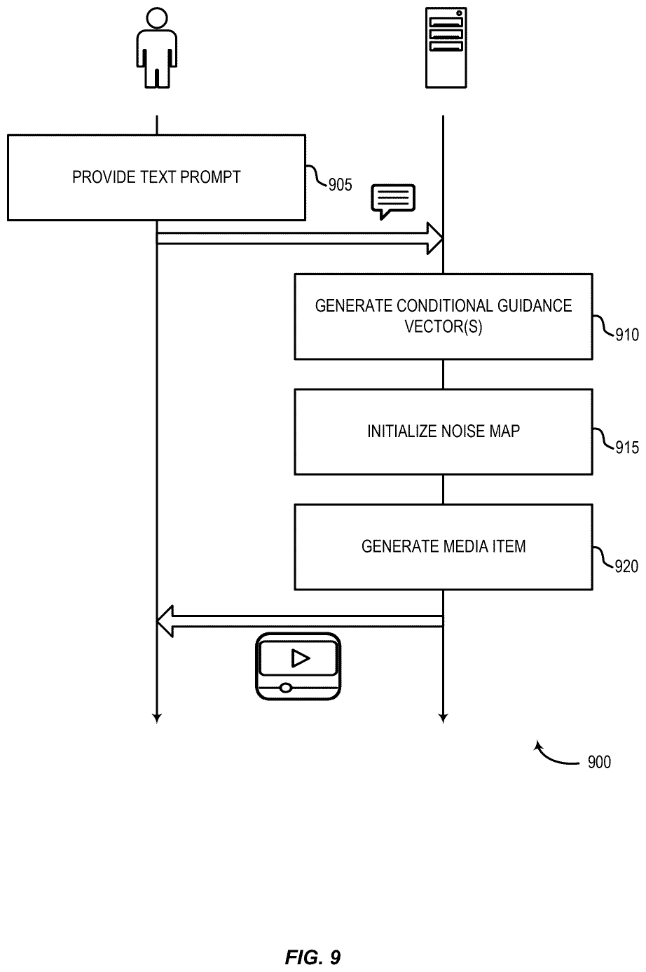

FIG. 9 shows an example of a method 900 for conditional media generation according to aspects of the present disclosure. In some examples, method 900 describes an operation of the video generation model 1415 described with reference to FIG. 14 such as an application of the guided diffusion model 700 described with reference to FIG. 7. In some examples, these operations are performed by a system including a processor executing a set of codes to control functional elements of an apparatus such as the video generation model described in FIG. 7.

Additionally or alternatively, steps of the method 900 may be performed using special-purpose hardware. Generally, these operations are performed according to the methods and processes described in accordance with aspects of the present disclosure. In some cases, the operations described herein are composed of various substeps or are performed in conjunction with other operations.

At operation 905, a user provides a text prompt describing content to be included in a generated media item. For example, a user may provide the prompt “a person playing with a cat”. In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder.

In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

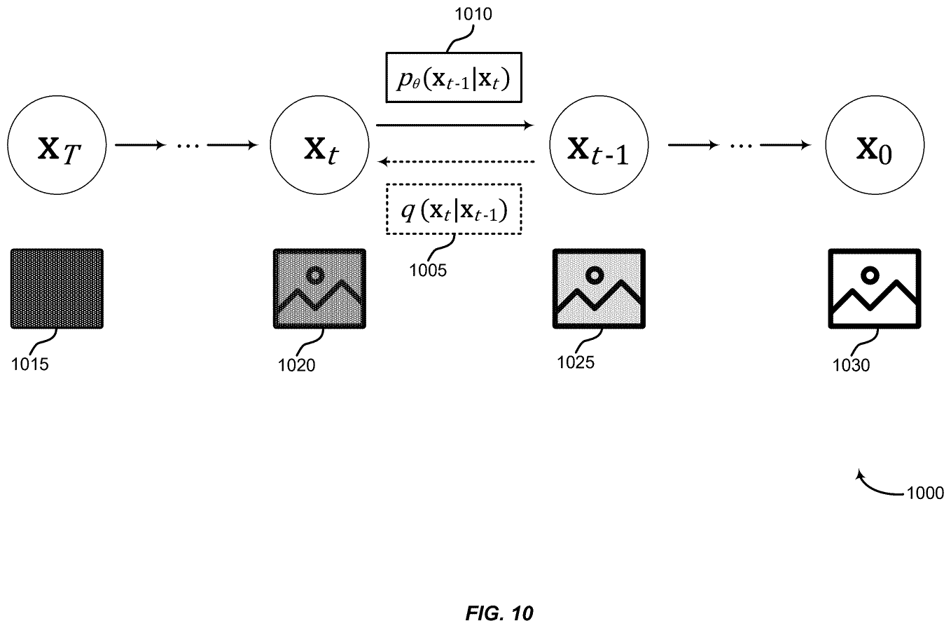

At operation 920, the system generates a media item based on the noise map and the conditional guidance vector. For example, the media item may be generated using a reverse diffusion process as described with reference to FIG. 10.

### Inference: Reverse Diffusion

FIG. 10 shows a diffusion process 1000 according to aspects of the present disclosure. In some examples, diffusion process 1000 describes an operation of the video generation model 1415 described with reference to FIG. 14, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ₋₁|xₜ). At each step t-1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x reverts back to x₀, the original media item 1030. The reverse process can be represented as:

p_{θ}(xₜ₋₁|xₜ):=N(xₜ₋₁;μ_{θ}(xₜ,t),Σ_{θ}(xₜ,t)). (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N (x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

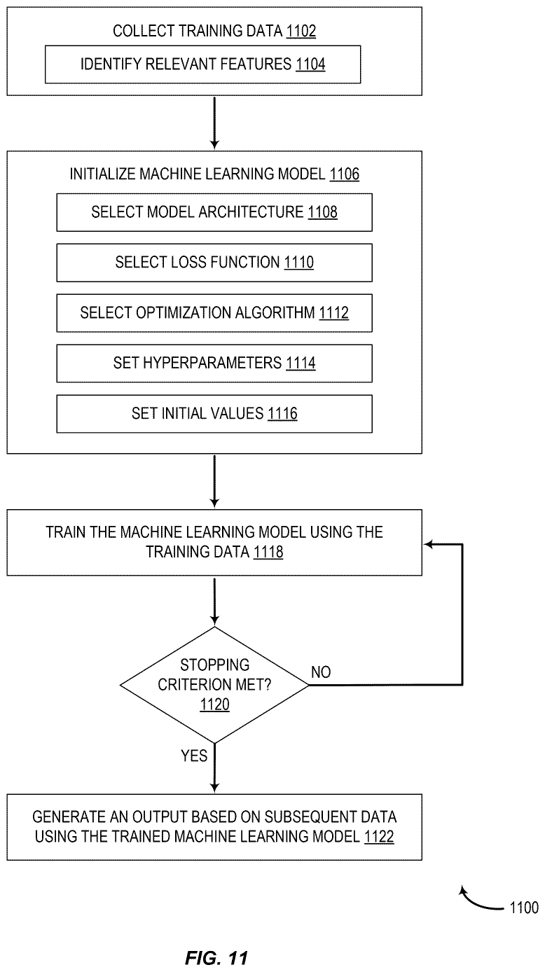

FIG. 11 is a flow diagram depicting an algorithm as a step-by-step procedure 1100 in an example implementation of operations performable for training a machine-learning model. In some embodiments, the procedure 1100 describes an operation of the training component 1425 described for configuring the video generation model 1415 as described with reference to FIG. 14. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (block 1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1116) examples of which includes initializing weights and biases of nodes to improve efficiency in training and computational resources consumption as part of training. Hyperparameters are also set (block 1114) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

### Training: Diffusion Training

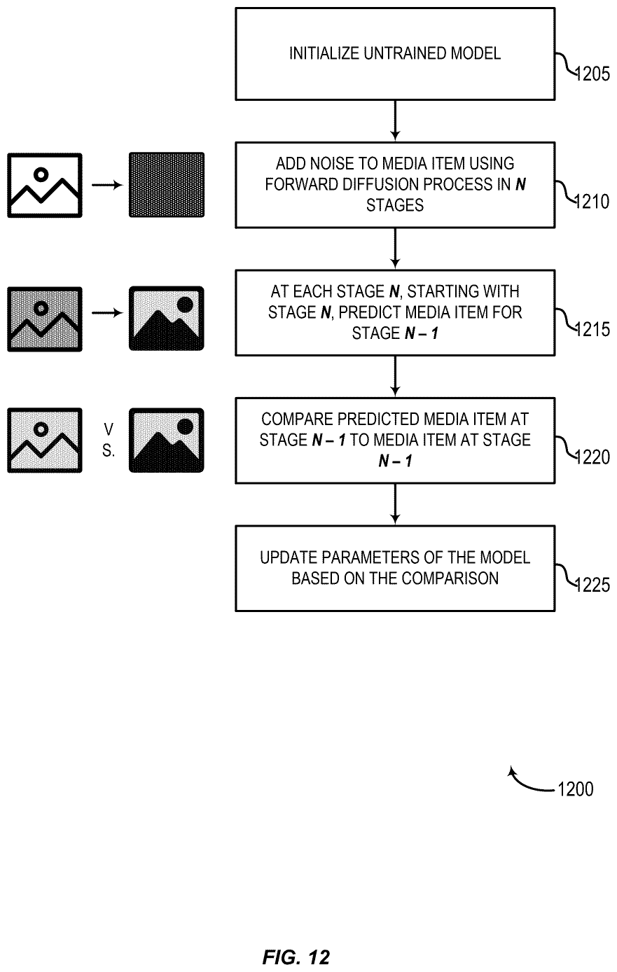

FIG. 12 shows an example of a method 1200 for training a diffusion model according to aspects of the present disclosure. In some embodiments, the method 1200 describes an operation of the training component 1425 described for configuring the video generation model 1415 as described with reference to FIG. 14. The method 1200 represents an example for training a reverse diffusion process as described above with reference to FIG. 10. In some examples, these operations are performed by a system including a processor executing a set of codes to control functional elements of an apparatus, such as the guided diffusion model described in FIG. 7.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1215, the system at each stage n, starting with stage N, a reverse diffusion process is used to predict the output or features at stage n-1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n-1 to an actual media item (or features), such as the output at stage n-1 or the original input. For example, given observed data x, the diffusion model may be trained to minimize the variational upper bound of the negative log-likelihood-log pe (x) of the training data.

At operation 1225, the system updates parameters of the model based on the comparison. For example, parameters of a U-Net may be updated using gradient descent. Time-dependent parameters of the Gaussian transitions can also be learned.

### System: Computing Device

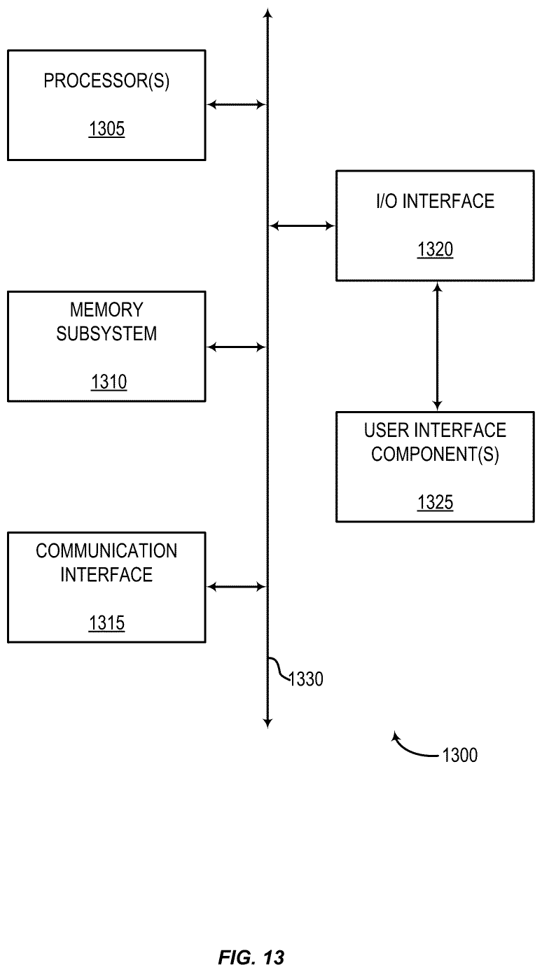

FIG. 13 shows an example of a computing device 1300 according to aspects of the present disclosure. The computing device 1300 may be an example of the video generation model evaluation system 1400 described with reference to FIG. 14. In one aspect, computing device 1300 includes processor(s) 1305, memory subsystem 1310, communication interface 1315, I/O interface 1320, user interface component(s) 1325, and channel 1330.

In some embodiments, computing device 1300 is an example of, or includes aspects of, the video generation model of FIG. 7. In some embodiments, computing device 1300 includes one or more processors 1305 that can execute instructions stored in memory subsystem 1310 to perform media generation.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

### System: Video Generation Model Evaluation System

FIG. 14 shows an example of a video generation model evaluation system 1400 according to aspects of the present disclosure. video generation model evaluation system 1400 may include an example of, or aspects of, the guided diffusion model described with reference to FIG. 7 and the U-Net described with reference to FIG. 8. In some embodiments, video generation model evaluation system 1400 includes processor unit 1405, memory unit 1410, video generation model 1415, I/O module 1420, and training component 1425. Training component 1425 updates parameters of the video generation model 1415 stored in memory unit 1410. In some examples, the training component 1425 is located outside the video generation model evaluation system 1400.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 7.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, video generation model evaluation system 1400 uses one or more processors of processor unit 1405 to execute instructions stored in memory unit 1410 to perform functions described herein. For example, the video generation model evaluation system 1400 may evaluate motion videos generated by video generation models.

The memory unit 1410 may include a video generation model 1415 trained to generate video sequences based on inputs that include a text prompt and an initial image frame. For example, after training, the video generation model 1415 may perform inferencing operations as described with reference to FIGS. 9 and 10 to generate a video sequence based on a text prompt and initial image frame.

In some embodiments, the video generation model 1415 is an Artificial neural network (ANN) such as the guided diffusion model described with reference to FIG. 7 and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of video generation model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train the video generation model 1415. For example, parameters of the video generation model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 5 and 6). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the video generation model 1415 can be used to make predictions on new, unseen data (i.e., during inference).

I/O module 1420 receives inputs from and transmits outputs of the video generation model evaluation system 1400 to other devices or users. For example, I/O module 1420 receives inputs for the video generation model 1415 and transmits outputs of the video generation model 1415. According to some aspects, I/O module 1420 is an example of the I/O interface 1320 described with reference to FIG. 13.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining an input pair including a text prompt and an initial image frame extracted from a ground truth video sequence;
generating, by a video generation model, a video sequence depicting motion of at least one object based on the text prompt and the initial image frame;
determining motion data representing the motion of the at least one object in the generated video sequence;
scoring the video generation model in one or more motion categories based on the motion data;
determining the scoring of the video generation model indicates high motion accuracy for the generated video sequence; and
providing the generated video sequence as an output video sequence.

2. The method of claim 1, wherein the text prompt defines a motion type to be generated for the generated video sequence, wherein the motion type is one of: linear motion, rotational motion, and oscillatory motion.

3. The method of claim 1, wherein determining the motion data representing the motion of the at least one object in the generated video sequence further comprises:
generating an optical flow map for the generated video sequence; and
generating, by a segmentation model, region of motion data for the generated video sequence.

4. The method of claim 1, wherein the input pair is selected from a dataset, and wherein the method further comprises:
generating the dataset by:
retrieving a plurality of ground truth video sequences for each of a plurality of object types;
pre-processing each of the plurality of ground truth video sequences; and
generating text prompts for each of the plurality of ground truth video sequences using a text prompt template.

5. The method of claim 4, wherein each of the plurality of ground truth video sequences includes a static camera and a single object in motion.

6. The method of claim 1, further comprising:
providing the generated scores as feedback to the video generation model.

7. The method of claim 1, wherein providing the generated video sequence as the output video sequence further comprises:
providing the text prompt and the initial image frame to one or more additional video generation models to generate additional generated video sequences;
generating additional scores for each of the one or more additional video generation models in the one or more motion categories based on the additional generated video sequences; and
selecting the generated video sequence as the output video sequence when the scoring of the video generation model for the generated video sequence indicate greater motion accuracy in comparison to the additional scores for the additional generated video sequences.

8. A non-transitory computer-readable medium storing executable instructions, which when executed by a processing device, cause the processing device to perform operations comprising:
obtaining an input pair including a text prompt and an initial image frame extracted from a ground truth video sequence;
generating, by a video generation model, a video sequence depicting motion of at least one object based on the text prompt and the initial image frame;
determining motion data representing the motion of the at least one object in the generated video sequence;
scoring the video generation model in one or more motion categories based on the motion data;
determining the scoring of the video generation model indicates high motion accuracy for the generated video sequence; and
providing the generated video sequence as an output video sequence.

9. The non-transitory computer-readable medium of claim 8, wherein the text prompt defines a motion type to be generated for the generated video sequence, wherein the motion type is one of: linear motion, rotational motion, and oscillatory motion.

10. The non-transitory computer-readable medium of claim 8, wherein the instructions to determine the motion data representing the motion of the at least one object in the generated video sequence further comprise:
generating an optical flow map for the generated video sequence; and
generating, by a segmentation model, region of motion data for the generated video sequence.

11. The non-transitory computer-readable medium of claim 8, wherein the input pair is selected from a dataset, and wherein the instructions further comprise:
generating the dataset by:
retrieving a plurality of ground truth video sequences for each of a plurality of object types;
pre-processing each of the plurality of ground truth video sequences; and
generating text prompts for each of the plurality of ground truth video sequences using a text prompt template.

12. The non-transitory computer-readable medium of claim 11, wherein each of the plurality of ground truth video sequences includes a static camera and a single object in motion.

13. The non-transitory computer-readable medium of claim 8, wherein the instructions further comprise:
providing the generated scores as feedback to the video generation model.

14. The non-transitory computer-readable medium of claim 8, wherein the instructions to provide the generated video sequence as the output video sequence further comprise:
providing the text prompt and the initial image frame to one or more additional video generation models to generate additional generated video sequences;
generating additional scores for each of the one or more additional video generation models in the one or more motion categories based on the additional generated video sequences; and
selecting the generated video sequence as the output video sequence when the scoring of the video generation model for the generated video sequence indicate greater motion accuracy in comparison to the additional scores for the additional generated video sequences.

15. A system comprising:
a memory component; and
a processing device coupled to the memory component, the processing device to perform operations comprising:
obtaining a plurality of ground truth video sequences, each ground truth video sequence including one of a plurality of motion types and one a plurality of object types;
generating text prompts for each of the plurality of ground truth video sequences using a text prompt template;
generating a dataset of paired text prompts and initial image frames extracted from the plurality of ground truth video sequences; and
evaluating motion modeling capabilities of a video generation model based on a video sequence generated by the video generation model using an input pair from the dataset.

16. The system of claim 15, wherein evaluating the motion modeling capabilities of the video generation model based on the video sequence generated by the video generation model using the input pair further comprise:
generating scores for the video generation model in one or more motion categories based on the video sequence generated by the video generation model; and
providing the generated scores as feedback to the video generation model.

17. The system of claim 16, wherein the operations of generating the scores for the video generation model in the one or more motion categories based on the generated video sequence further comprise:
generating an optical flow map for the video sequence generated by the video generation model;
generating, by a segmentation model, region of motion data for the video sequence generated by the video generation model; and
scoring the video generation model associated with the video sequence generated using the optical flow map and the region of motion data.

18. The system of claim 15, wherein the operations further comprise:
pre-processing each of the plurality of ground truth video sequences by temporally segmenting each of the plurality of ground truth video sequences to obtain a plurality of video segments with a matching duration.

19. The system of claim 15, wherein each of the text prompts defines a motion speed and a motion direction for an object in an initial video frame from a ground truth video sequence from the plurality of ground truth video sequences.

20. The system of claim 15, wherein plurality of motion types include: linear motion, rotational motion, and oscillatory motion.
